(19) United States
(12) Patent Application Publication
(10) Pub. No.: US 2008/0163900 A1
(43) Pub. Date: Jul. 10, 2008

(54) IPA DELIVERY SYSTEM FOR DRYING

(76) Inventors: DOUGLAS RICHARDS, Meridian, ID (US); Evanson G. Baiya, Nampa, ID (US); John J. Rosato, Boise, ID (US); Madhava Rao Yalamanchili, Eagle, ID (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 11/685,426

(22) Filed: Mar. 13, 2007

Related U.S. Application Data
(60) Provisional application No. 60/883,705, filed on Jan. 5, 2007.

(51) Int. Cl. B08B 3/08

(52) U.S. Cl. 134/89; 134/88

(57) ABSTRACT

A method and system for cleaning a batch of substrates is provided. The system includes a first cluster of vertical processing chambers, an IPA reservoir, and an IPA delivery system in fluid communication with the IPA reservoir and the first cluster of vertical processing chambers, wherein the IPA delivery system is adapted to transfer IPA vapor between the IPA reservoir and the first cluster of vertical processing chambers. In certain embodiments, the system further comprises a first main circulation tank, a second main circulation tank, a reservoir-cluster recirculation circuit in fluid communication with the first main circulation tank and the second main circulation tank and with each processing chamber in the first cluster of vertical processing chambers, and a dosing circuit comprising a plurality of additive sources in fluid communication with the first main circulation tank and the second main circulation tank.

### CROSS-REFERENCE TO RELATED APPLICATIONS

This application claims benefit of U.S. provisional patent application Ser. No. 60/883,705, filed Jan. 5, 2007, which is herein incorporated by reference.

### BACKGROUND OF THE INVENTION

1. Field of the Invention

Embodiments of the present invention as recited by the claims generally relate to systems and techniques for cleaning and drying a substrate. More particularly, the present invention relates to systems and methods for delivering solvents used in vapor processing of substrates, including silicon wafers used in the manufacture of semiconductors.

2. Description of the Related Art

As semiconductor device geometries continue to decrease, the importance of ultra clean processing increases. Aqueous cleaning within a tank of fluid (or a bath) followed by rinsing bath (e.g., within a separate tank, or by replacing the cleaning tank fluid) achieves desirable cleaning levels. After removal from the rinsing bath, absent use of a drying apparatus, the bath fluid would evaporate from the substrate's surface causing streaking, spotting and/or leaving bath residue on the surface of the substrate. Such streaking, spotting and residue can cause subsequent device failure. Accordingly, much attention has been directed to improved methods for drying a substrate as it is removed from an aqueous bath.

A method know as Marangoni drying creates a surface tension gradient to induce bath fluid to flow from the substrate in a manner that leaves the substrate virtually free of bath fluid, and thus may avoid streaking, spotting or residue marks. Specifically, during Marangoni drying a solvent miscible with the bath fluid (e.g., IPA vapor) is introduced to a fluid meniscus which forms as the substrate is lifted from the bath or as the bath fluid is drained past the substrate. The solvent vapor is absorbed along the surface of the fluid, with the concentration of the absorbed vapor being higher at the tip of the meniscus. The higher concentration of absorbed vapor causes surface tension to be lower at the tip of the meniscus than in the bulk of the bath fluid, causing the bath fluid to flow from the drying meniscus toward the bulk bath fluid. Such flow is known as a “Marangoni” flow, and can be employed to achieve substrate drying without leaving streaks, spotting or bath residue on the substrate.

Therefore, there is a need for improved systems and methods for drying a substrate as it is removed from an aqueous bath.

### SUMMARY OF THE INVENTION

Embodiments of the invention as recited in the claims generally relate to systems and techniques for cleaning and drying a substrate.

In certain embodiments a system for cleaning a batch of substrates is provided. The system includes a first cluster of vertical processing chambers, an IPA reservoir, and an IPA delivery system in fluid communication with the IPA reservoir and the first cluster of vertical processing chambers, wherein the IPA delivery system is adapted to transfer IPA vapor between the IPA reservoir and the first cluster of vertical processing chambers. In certain embodiments, the system further comprises a first main circulation tank, a second main circulation tank, a reservoir-cluster recirculation circuit in fluid communication with the first main circulation tank and the second main circulation tank and with each processing chamber in the first cluster of vertical processing chambers, and a dosing circuit comprising a plurality of additive sources in fluid communication with the first main circulation tank and the second main circulation tank.

In certain embodiments a system for cleaning a batch of substrates is provided. The system includes at least three vertical processing chambers each configured to process a single substrate and a fluid delivery system in fluid communication with each of the at least vertical processing chambers, the fluid delivery system configured to provide IPA vapor to each of the at least three vertical processing chambers.

In certain embodiments a method of drying a substrate is provided. The method comprises generating an IPA vapor in a vapor generator, flowing a heated carrier gas into the vapor generator, delivering the IPA vapor to multiple processing chambers, wherein each processing chamber is configured to vertically process a single substrate, and maintaining a uniform flow rate, concentration, and temperature while delivering the IPA vapor to the multiple processing chambers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is an isometric view illustrating an exemplary processing system;

FIG. 1B is a plan view of the processing system of FIG. 1A;

FIG. 2 is a fluid flow circuit schematic diagram of the processing system of FIG. 1A and FIG. 1B;

FIG. 3 is a fluid flow circuit schematic diagram of the IPA module of the exemplary processing system;

FIG. 4 is a fluid flow circuit schematic diagram of the N₂ module of the exemplary processing system;

FIG. 5 is a fluid flow circuit schematic diagram of the recirculator module of the exemplary processing system;

FIG. 6 is a fluid flow circuit schematic diagram of the spiking module of the exemplary processing system; and

FIG. 7 illustrates a cross sectional view of an exemplary substrate processing chamber.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

The present invention is described here with respect to a particularly preferred embodiment in which isopropyl alcohol (IPA) is used to dry silicon wafers. It will be recognized by those of ordinary skill in the art that these systems and methods can be used to practice a variety of vapor processing techniques, on a variety of substrates using a variety of chemicals. The use of the IPA/silicon wafer example is intended to be illustrative and not limiting.

In certain embodiments, chambers for processing a single substrate and associated processes are disclosed. The chambers and methods may be configured to perform substrate surface cleaning/surface preparation processes, such as etching, cleaning, rinsing and/or drying a single substrate. Although the illustrative chambers are described for use with one substrate, the embodiments described herein may be used for cleaning a plurality of substrates in a single chamber. Similar processing chambers may be found in U.S. patent application Ser. No. 11/460,049, filed Jul. 26, 2006, and in U.S. patent application Ser. No. 11/445,707, filed Jun. 2, 2006, both of which are incorporated herein by reference. Certain embodiments may be adapted to be disposed on a substrate surface cleaning/surface preparation tool available from Applied Materials, Inc., of Santa Clara, Calif., sold under the trade name “Emersion.”

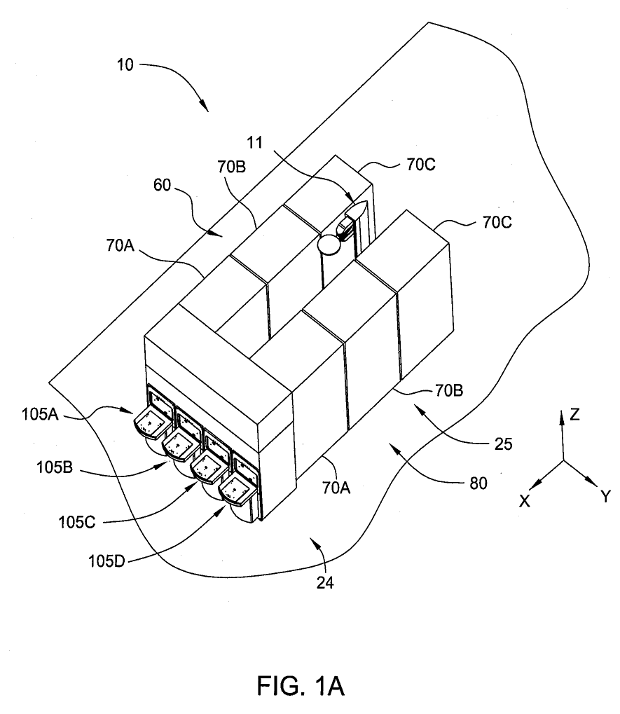

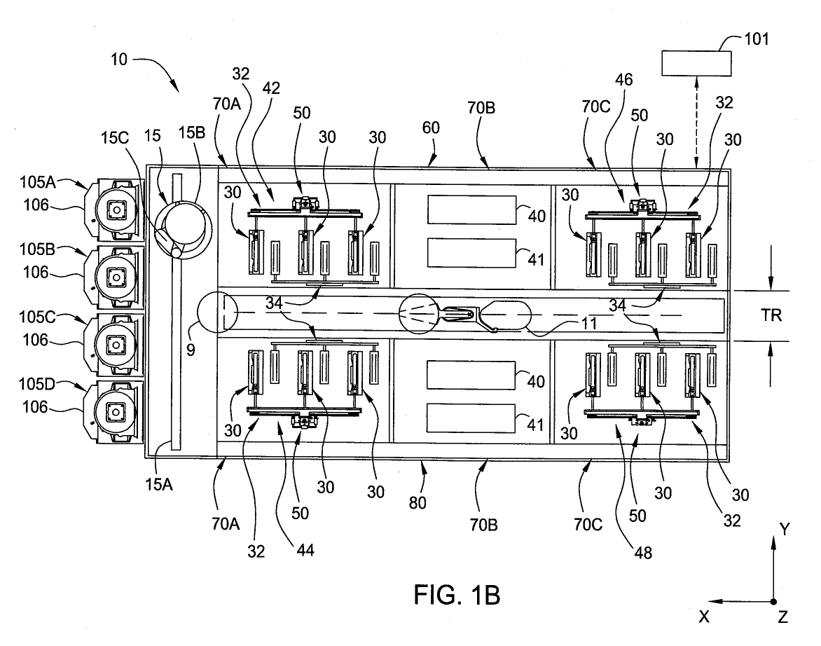

FIG. 1A is an isometric view illustrating an exemplary processing system 10 containing the fluid delivery system 40 of the present invention. FIG. 1B is a plan view of the exemplary processing system 10 shown in FIG. 1A. FIG. 1A illustrates an embodiment of the processing system 10 which contains a single robot that is adapted to access the various process chambers positioned in a first processing rack 60 and a second processing rack 80. Certain embodiments of the processing system 10, as illustrated in FIG. 1A, contain a front end module 24 and a central module 25. The central module 25 generally contains the first processing rack 60, the second processing rack 80, and one or more robot assemblies 11. In certain embodiments, the central module 25 contains a robot assembly 11, a first processing rack 60 and a second processing rack 80. The first processing rack 60 and a second processing rack 80 contain various processing chambers, e.g., process chambers 30, shown in FIG. 1B, that are adapted to perform the various processing steps found in a substrate processing sequence.

The front end module 24 generally contains one or more pod assemblies 105A-D and a front end robot assembly 15 shown in FIG. 1B. The one or more pod assemblies 105A-D, or front-end opening unified pods (FOUPs), are generally adapted to accept one or more cassettes 106 that may contain one or more substrates “W”, or wafers, that are to be processed in the processing system 10. In certain embodiments, the cassettes are adapted to retain the one or more substrates in horizontal orientation (i.e., processing surface, or surface on which the semiconductor devices are formed, is facing up or facing down). In one aspect, the front end module 24 also contains one or more pass-through positions 9 that allow the front end robot assembly 15 and the one or more robot assembly 11 in the central module 25 to exchange substrates.

The first processing rack 60 and the second processing rack 80 may contain one or more modules 70A-70C that contain process chambers and/or the process chamber support hardware. The first processing rack 60 and second processing rack 80 generally contain one or more processing chambers that are adapted to perform some desired semiconductor or flat panel display device fabrication processing steps on a substrate. For example, in FIG. 1B the first process rack 60 contains three processing chambers also know as a cluster. In certain embodiments, these device fabrication processing steps may include cleaning a surface of the substrate, etching a surface of the substrate, or exposing the substrate to some form of energy to cause a physical or chemical change to one or more regions on the substrate. In certain embodiments, the first processing rack 60 and second processing rack 80 contain one or more processing chambers that can be adapted to perform one or more cleaning processing sequence steps. Examples of processing chambers and or systems that may be adapted to perform one or more cleaning processes on a substrate and may be adapted to benefit one or more aspects of the invention is further described in the commonly assigned U.S. patent application Ser. No. 09/891,849, filed Jun. 25, 2001, now published as U.S. Patent Application Publication No. 2002-0029788, entitled METHOD AND APPARATUS FOR WAFER CLEANING and U.S. patent application Ser. No. 09/945,454, filed Aug. 31, 2001, now published as U.S. Patent Application Publication No. 2003-0045098, entitled METHOD AND APPARATUS FOR PROCESSING A WAFER.

FIG. 1B illustrates a plan view of the processing system 10 that has a first processing rack 60 and a second processing rack 80 that each contain two processing chamber arrays 32 that contain a total of three process chambers 30 for a total of six process chambers 30 for each processing rack. In one aspect, the processing racks 60 and 80 each contain three modules 70A-70C that either contain processing chambers or supporting equipment. In the configuration shown, modules 70A and 70C each contain three process chambers 30, each grouping of three process chambers is referred to as a cluster, that are positioned along a desirable direction (i.e., X-direction) and module 70B contains the process supporting components, such as the fluid delivery system 40 and other supporting components 41 of the present invention. The first processing rack 60 contains cluster A 42 and cluster C 46. The second processing rack 80 contains cluster B 44 and cluster D 48. The orientation, positioning, type and number of process chambers shown in FIG. 1 B are not intended to be limiting as to the scope of the invention, but are intended to illustrate an embodiment of the invention.

Referring to FIG. 1B, in certain embodiments, the front end robot assembly 15 is adapted to transfer substrates between a cassette 106 mounted in a pod assembly 105A-D and the one or more of the pass-through positions 9. The front end robot assembly 15 generally contains a horizontal motion assembly 15A and a robot 15B, which in combination are able to position a substrate in a desired horizontal and/or vertical position in the front end module 24 or the adjoining positions in the central module 25. The front end robot assembly 15 is adapted to transfer one or more substrates using one or more robot blades 15C, by use commands sent from a system controller 101 (discussed below). In certain sequences the front end robot assembly 15 is adapted to transfer a substrate from the cassette 106 to the pass-through positions 9. Generally, a pass-through position is a substrate staging area that may contain a pass-through processing chamber that is similar to a conventional substrate cassette 106, which is able to accept one or more substrates from a front end robot 15B so that it can be removed and repositioned by robot assembly 11.

Referring to FIGS. 1A-B, the first robot assembly 11 is adapted to transfer substrates to the various processing chambers contained in the first processing rack 60 and the second processing rack 80. In certain embodiments, as shown in FIG. 1B, the substrates are transferred from the robot assembly 11 to a separate actuator assembly 50 that is adapted to position the substrate in the process chambers (e.g., reference numeral 30). In certain embodiments, the modules 70A and 70C each contain a chamber pass-through assembly 34 that is adapted to interface with the robot assembly 11 and the actuator assembly 50.

The system controller 101 is adapted to control the position and motion of the various components used to complete the transferring process. The system controller 101 is generally designed to facilitate the control and automation of the overall system and typically includes a central processing unit (CPU) (not shown), memory (not shown), and support circuits (or I/O) (not shown). The CPU may be one of any form of computer processors that are used in industrial settings for controlling various system functions, chamber processes and support hardware (e.g., detectors, robots, motors, fluid delivery hardware, gas sources hardware, etc.) and monitor the system and chamber processes (e.g., chamber temperature, process sequence throughput, chamber process time, I/O signals, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 101 determines which tasks are performable on a substrate. Preferably, the program is software readable by the system controller 101, which includes code to perform tasks relating to monitoring and execution of the processing sequence tasks and various chamber process recipe steps.

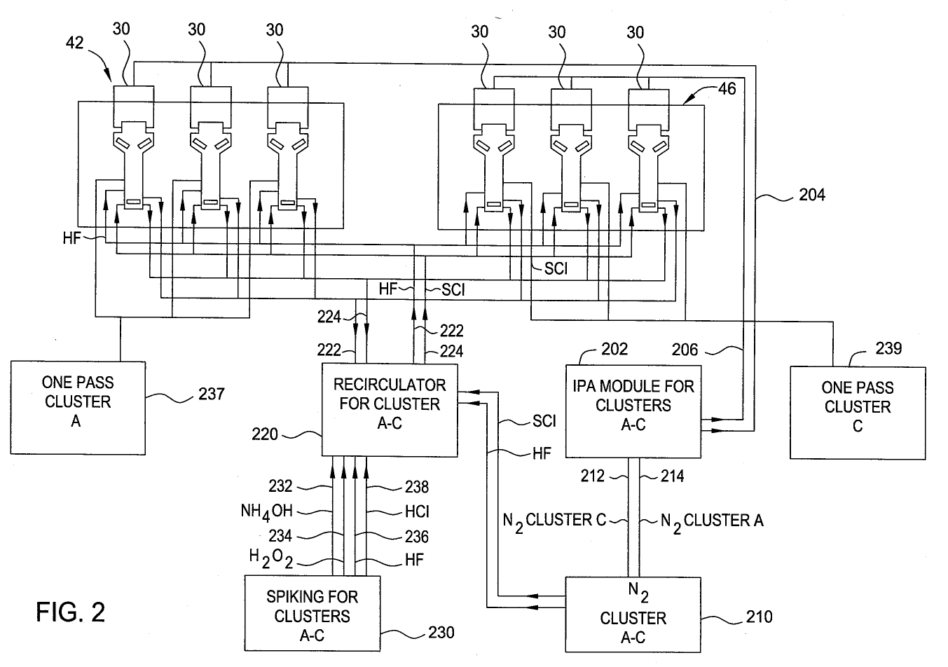

FIG. 2 is a fluid flow circuit schematic diagram of the fluid delivery system 40 of the processing system of FIG. 1A and FIG. 1B. Those of ordinary skill in the art will recognize that additional fluid flow devices and various control features can be added while still within the spirit and scope of the present invention. The fluid delivery system 40 is generally configured to supply a processing solution to each process chamber 30 that requires the process solution. More particularly, the fluid delivery system 40 is further configured to simultaneously supply processing solutions to each process chamber 30. For example, the fluid delivery system 40 may simultaneously provide HF, standard clean 1 (SC1), or IPA to each process chamber 30 located in either cluster A 42 and cluster C 46 or cluster B 44 shown in FIG. 1B and cluster D 48 shown in FIG. 1B. Thus allowing each process chamber 30 to share a common chemistry and maintain a common wafer history for the wafers in each batch. Each processing solution provided to all chambers may also be uniform in flow, temperature, and concentration. Etching process used with the system may include selective etchants and non-selective etchants (NSE), buffered etchants (LAL as one example), and buffered oxide etchants (BOE), among others. Cleaning chemicals may include standard clean 1 (SC1), standard clean 2 (SC2), RCA, an ammonia/peroxide mixture (APM), AM1 chemistry (available from Applied Materials, Inc., of Santa Clara, Calif.), among other cleaning solutions and chemicals.

IPA vapor is used in each process chamber 30 for drying a substrate. IPA vapor is supplied to each process chamber 30 in cluster A 42 and cluster C 46 via an IPA module 202. The IPA module 202 is coupled to cluster A 42 via a first supply line 204. The IPA module 202 is coupled to cluster C 46 via a second supply line 206. The liquid IPA is heated and vaporized during a vapor generation phase which takes place in the IPA module 202. Heated nitrogen is flown over the IPA. The nitrogen source is contained in a nitrogen module 210 which supplies nitrogen to the IPA module 202 via a first nitrogen supply line 212 and a second nitrogen supply line 214. Although the present embodiment is discussed with reference to nitrogen, it should be recognized by one of ordinary skill in the art that any suitable carrier gas, including for example, argon, helium, and xenon, may be used with the present invention. The nitrogen module 210 also supplies nitrogen to a recirculator module 220 for cluster A 42 and cluster C 46. The recirculator module 220 supplies HF via a first fluid recirculation circuit 222 to each process chamber 30 of cluster A 42 and cluster C 46. The recirculator module 220 supplies SC1 chemistry to each of the process chambers 30 in cluster A 42 and cluster C 46 via a second fluid recirculation circuit 224. Spent HF and SC1 chemistry is transferred from the process chamber 30 to the reicirculator module via the first fluid recirculation circuit 222 and the second fluid recirculation circuit 222.

A spiking module 230 supplies NH₄OH, H₂O₂, HF, and HCl to the recirculator via supply lines 232, 234, 236, and 238. In certain embodiments, a first one pass cluster tank 237 for cluster A 42 and a second one pass cluster tank 239 for cluster B 44 are connected (connections not shown for simplicity) to the fluid delivery system 40. The one pass tanks may be used for storage and/or disposal of excess and used solution such as DI water, NH₄OH, H₂O₂, HF, and HCl. The one pass cluster tanks 237, 239 are connected to each process chamber 30 within their respective cluster. Each one pass tank is also connected to hot and cold DI water supplies and drains for each respective solution. Although not shown for simplicity, it should be understood that each process chamber 30 is connected to both hot and cold DI water supplies. Hot and cold DI water supplies are also connected to each module, such as, the spiking module 230, the recirculator module 220, the IPA module 202, the nitrogen module 210, as well as the first one pass cluster tank 237 and the second one pass cluster tank 239.

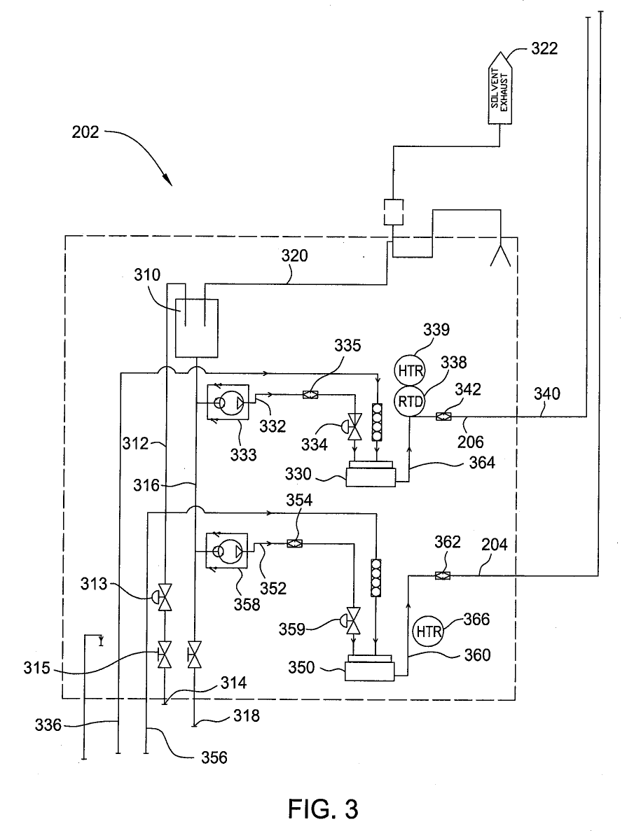

FIG. 3 is a fluid flow circuit schematic diagram of the IPA module 202 of the exemplary processing system 10 of the present invention. The IPA is stored in an IPA reservoir 310 which is supplied by a supply line 312 coupled to a facility IPA supply 314. The supply line 312 also includes a pneumatic valve 313 and a manual control and/or shut off valve 315. The IPA reservoir 310 may also contain one or more liquid level sensors monitored by controller 101. When the IPA in the IPA reservoir 310 drops below a predetermined level the controller may automatically activate the pneumatic valve 313 releasing more IPA into the IPA reservoir 310. The IPA reservoir 310 is coupled by line 314 to a solvent drain 318 used for draining solvent from the IPA reservoir 310. The IPA reservoir 310 is also coupled by line 320 to a solvent exhaust 322 used for exhausting solvent fumes from the IPA reservoir 310. Both the solvent drain 318 and the solvent exhaust 322 may be monitored and controlled by the controller 101.

The IPA reservoir 310 is coupled to a first IPA vapor generator 330 by line 316 and a line 332. A predetermined volume of IPA is introduced in the first IPA vapor generator 330 through line 332. To control the IPA flow rate into the first IPA vapor generator 330, line 332 contains a metering pump 333 and a pneumatic valve 334 which may be monitored and controlled by the controller 101. Line 332 also contains a filter 335 to filter out any impurities present in the IPA. The predetermined volume of IPA is injected onto a heated surface within the IPA vapor generator 330. The IPA is heated on the heated surface to a temperature preferably greater than the boiling point of IPA (which is 82.4° C. at 1 atm), for example about 120° C. Heating the IPA increases the rate at which IPA vapor is generated and thus expedites the process, creating an IPA vapor cloud. When the IPA vapor is needed in the process chamber 30, nitrogen gas is passed through nitrogen supply line 336 into the first IPA vapor generator 330, and carries the IPA vapor out of the first IPA generator 330 via line 206. In certain embodiments, the nitrogen gas flow rate may be between about 15 liters/minute and 140 liters/minute. In certain embodiments, the nitrogen gas may be heated to between about 120° C. and about 170° C. In certain embodiments, the uniform flow rate of the IPA vapor is between about 0.05 mL/second and about 1.5 mL/second. The nitrogen supply line 336 contains a resistive thermal device 338 for monitoring the temperature of the nitrogen gas and a heater 339 for controlling the temperature of the nitrogen gas supplied to the first IPA vapor generator 330. An IPA filter 342 is disposed in line 340 for filtering the IPA vapor and nitrogen being supplied from the first IPA vapor generator 330 to the process chamber 30. IPA vapor flows from the first IPA generator 330 through the line 206 and filter 342 and then to cluster C 46. Line 206 contains a heater 364 for heating and maintaining the temperature of the combined IPA vapor and nitrogen gas.

The IPA reservoir 310 is coupled to a second IPA vapor generator 350 by line 316 and line 352. Line 352 also contains a metering pump 358 and a pneumatic valve 359 which may be monitored and controlled by the controller 101. An IPA filter 354 is disposed in line 352 to filter the IPA being supplied to the second IPA vapor generator 350. When the IPA vapor is needed in the process chamber 30, nitrogen gas is passed through a second nitrogen supply line 356 into the second IPA vapor generator 350, and carries the IPA vapor out of the second IPA vapor generator 350 via line 360. An IPA filter 362 is disposed in line 204 for filtering the IPA vapor and nitrogen gas being supplied from the second IPA vapor generator 350 to the process chamber 30. IPA vapor and nitrogen gas flows from the second IPA generator 350 through the line 204 and filter 362 and then to cluster A 42. Line 204 contains a heater 366 for heating and maintaining the temperature of the combined IPA vapor and nitrogen gas.

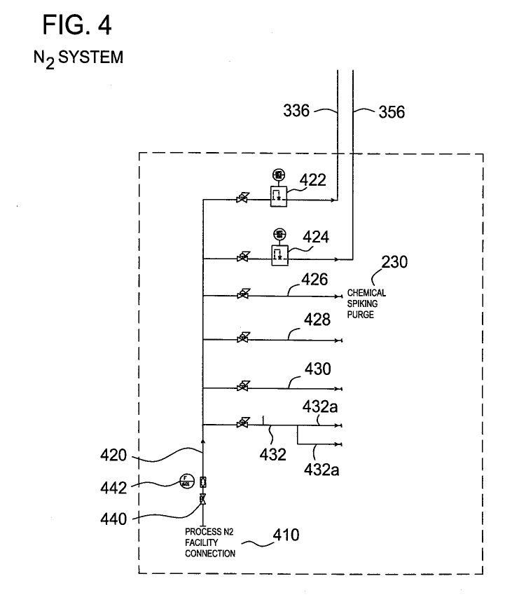

FIG. 4 is a fluid flow circuit schematic diagram of the N₂ module 210 of the exemplary processing system 10. As discussed above, the use of nitrogen is exemplary and any suitable carrier gas/purge gas may be used with the present system. Nitrogen is supplied from a facility nitrogen supply 410 to a main nitrogen supply line 420. The nitrogen supply line 420 a manual shutoff valve 440 and a filter 442 for filtering contaminants from the nitrogen gas. Nitrogen is used in several different applications within the processing system. For example, the first nitrogen line 336 supplies nitrogen, which is used to flow heated nitrogen over the liquid IPA during the vapor generation phase, to the first IPA vapor generator. A first mass flow controller 422 is used to control the flow of IPA through the supply line 336. The second nitrogen supply line 356 supplies nitrogen to the second IPA vapor generator 350. A second mass flow controller 424 is used to control the flow of IPA through the second nitrogen supply line 356. A third nitrogen supply line 426 supplies nitrogen gas which is used as a purge gas to the spiking module 230. A fourth nitrogen supply line 428 supplies nitrogen gas to each process chamber 30 for use during the wafer drying cycle. A fifth nitrogen supply line 430 is used for a directed purge. A sixth nitrogen supply line 432 includes two branched supply lines 432a that are used for the chamber exhaust system. All nitrogen supply lines contain pressure regulators, pressure transducers, and pressure indicators which are not described in detail for the sake of brevity.

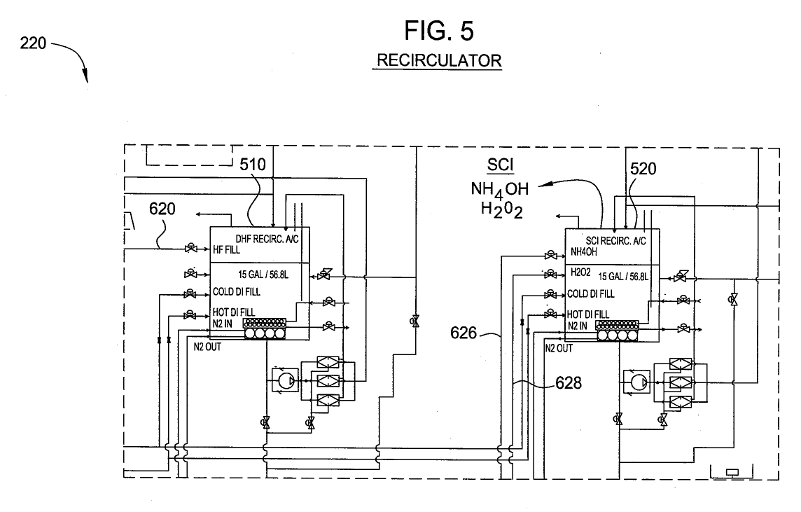

FIG. 5 is a fluid flow circuit schematic diagram of the recirculator module 220 of the exemplary processing system 10. The recirculator module 220 for cluster A 42 and cluster C 46 contains a first main recirculation tank 510 for HF and a second main recirculation tank 520 for SC1 chemistry (NH₄OH and H₂O₂). It should be understood by one of ordinary skill in the art that other chemistries may be used with the system. Both the first main recirculation tank 510 and the second main recirculation tank 520 contain liquid level sensors monitored and controlled by controller 101 for monitoring the level of fluids present. The first main recirculation tank 510 is coupled by the first fluid recirculation circuit 222, which recirculates the replenished HF from the first main recirculation tank 510 to each process chamber 30 in cluster A 42 and cluster C 46 and returns spent HF from the process chambers 30 back to the first main recirculation tank 510 of the recirculator module 220. It should be appreciated that, in this embodiment, the HF recirculates between the first main recirculation tank 510 and the process chambers 30 while remaining on the tool platform. By recirculating locally in the first fluid recirculation circuit 510, the complexity of the overall system is substantially reduced. The second main recirculation tank 520 is coupled by the second fluid recirculation circuit 224, which recirculates replenished SC-1 chemistry from the second main recirculation tank 520 to each process chamber 30 in cluster A 42 and cluster C 46 and returns spent SC-1 back through the second fluid recirculation circuit 224 of the recirculator module 220 of the processing system to the second main recirculation tank 520. It should be appreciated that, in this embodiment, the SC-1 recirculates between the second main recirculation tank 520 and the process chambers 30 while remaining on the tool platform. By recirculating locally in the second fluid recirculation circuit 224, the complexity of the overall system is substantially reduced.

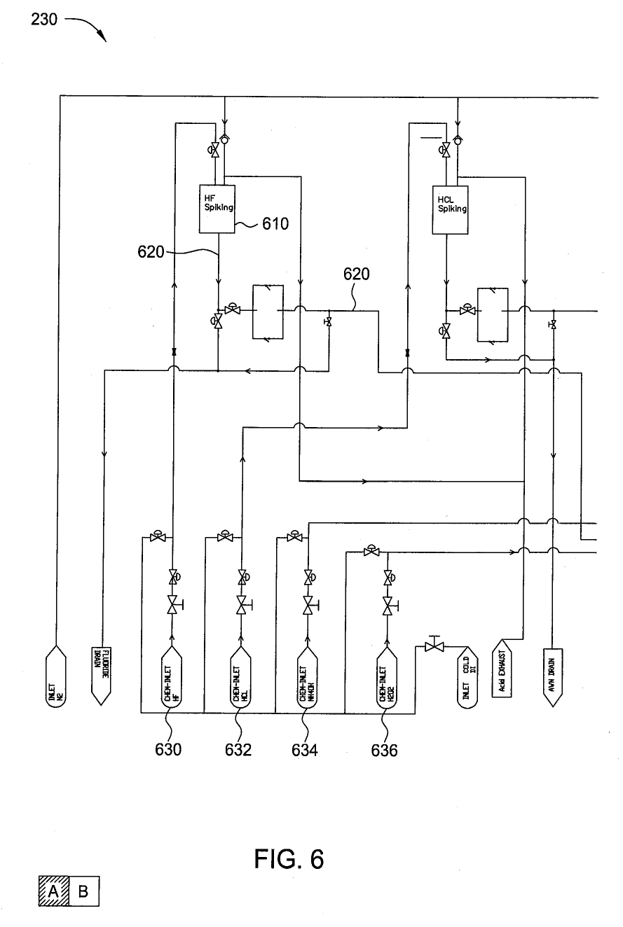

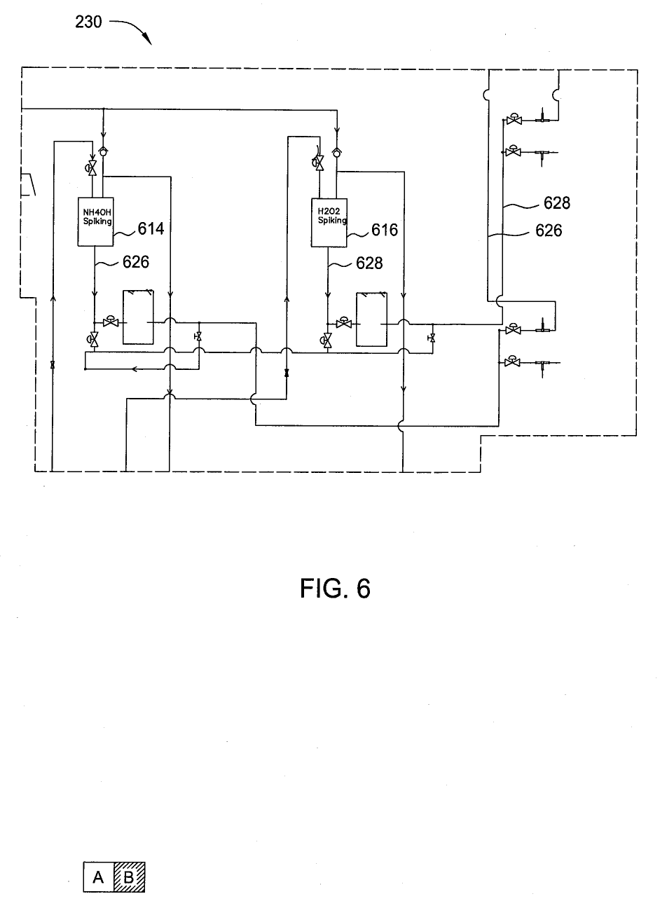

FIG. 6 is a fluid flow circuit schematic diagram of the spiking module 230 of the exemplary processing system 10. The spiking module 230 has four reservoirs comprising various additive sources. Typically, the reservoirs include a first reservoir 610 containing HF, a second reservoir 612 containing HCl, a third reservoir 614 containing NH₄OH, and a fourth reservoir 616 containing H₂O₂. The first reservoir 610 supplies HF to the first main recirculation tank 510 via a supply line 620. The second reservoir 612 may supply HCl to each process chamber via a supply line (connections not shown for simplicity). The third reservoir 614 supplies NH₄OH to the second main recirculation tank 520 via a supply line 626. The fourth reservoir 616 supplies H₂O₂ to the second main recirculation tank 520 via a supply line 628. All supply lines contain pneumatic valves for controlling the flow of additives into the first main recirculation tank 510 and the second main recirculation tank 520. The first reservoir 610 is coupled to a HF source 630 for supplying HF to the system. The second reservoir 612 is coupled to a HCl (hydrochloric acid) source 632 for supplying HCl to the system. The third reservoir 614 is coupled to a NH₄OH source 634 for supplying ammonium hydroxide to the system. The fourth reservoir 616 is coupled to a H₂O₂ source 636 for supplying hydrogen peroxide to the system.

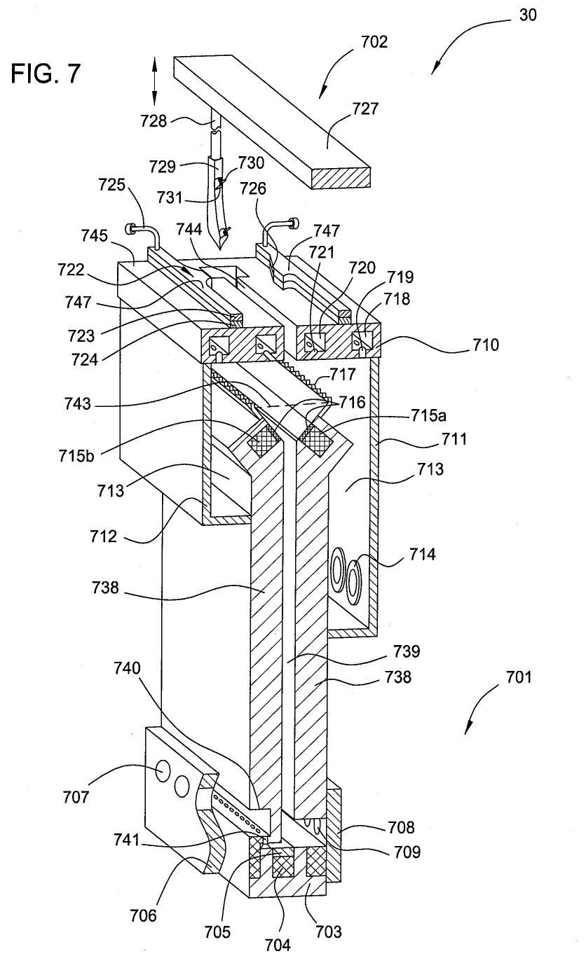

FIG. 7 illustrates a cross sectional view of an exemplary substrate process chamber 30 for use in accordance with certain embodiments of the present invention. The substrate process chamber 30 comprises a chamber body 701 configured to retain a liquid and/or a vapor processing environment and a substrate transfer assembly 702 configured to transfer a substrate in and out the chamber body 701.

The lower portion of the chamber body 701 generally comprises side walls 738 and a bottom wall 703 defining a lower processing volume 739. The lower processing volume 739 may have a rectangular shape configured to retain fluid for immersing a substrate therein. A weir 717 is formed on top of the side walls 738 to allow fluid in the lower processing volume 739 to overflow. The upper portion of the chamber body 701 comprises overflow members 711 and 712 configured to collect fluid flowing over the weir 717 from the lower processing volume 739. The upper portion of the chamber body 701 further comprises a chamber lid 710 having an opening 744 formed therein. The opening 744 is configured to allow the substrate transfer assembly 702 to transfer at least one substrate in and out the chamber body 701.

An inlet manifold 740 configured to fill the lower processing volume 739 with processing fluid is formed on the sidewall 738 near the bottom of the lower portion of the chamber body 701. The inlet manifold 740 has a plurality of apertures 741 opening to the bottom of the lower processing volume 739. An inlet assembly 706 having a plurality of inlet ports 707 is connected to the inlet manifold 740. Each of the plurality of inlet ports 707 may be connected with an independent fluid source, for example, inlet ports 707 may be connected to the first fluid recirculation circuit 222 for supplying HF to each process chamber 30. The inlet ports 707 may also be connected to the second fluid recirculation circuit 224 for supply SC1 to each process chamber 30. Other chemicals for etching, cleaning, and DI water for rinsing, such that different fluids or combination of fluids may be supplied to the lower processing volume 739 for different processes may also be supplied through inlet ports 707.

During processing, fluid may flow in from one or more of the inlet ports 707 to fill the lower processing volume 739 from the bottom via the plurality of apertures 741. Flow rates for DI water may be between about 1 liters per minute (lpm) and about 60 lpm, such as between about 35 lpm to about 55 lpm for a high flow rate, and about 1 lpm to about 10 lpm for a low flow rate. Standard clean 1 (SC1) may be supplied to the lower processing volume 739 at a rate between about 15 lpm to about 25 lpm, while an etchant, such as hydrofluoric acid (HF), may be supplied at a rate of about 15 lpm to about 25 lpm.

As the processing fluid fills up the lower processing volume 739 and reaches the weir 717, the processing fluid overflows from the weir 717 to an upper processing volume 713 and is connected by the overflow members 711 and 712. A plurality of outlet ports 714 configured to drain the collected fluid may be formed on the overflow member 711. The plurality of outlet ports 714 may be connected to a pump system. In certain embodiments, each of the plurality of outlet ports 714 may form an independent drain path dedicated to a particular processing fluid. In certain embodiments, each drain path may be routed to a negatively pressurized container to facilitate removal, draining and/or recycling of the processing fluid. In certain embodiments, the overflow member 712 may be positioned higher than the overflow member 711 and fluid collected in the overflow member 712 may flow to the overflow member 711 through a conduit.

In certain embodiments, a draining assembly 708 may be coupled to the sidewall 738 near the bottom of the lower processing volume 739 and in fluid communication with the lower processing volume 739. The draining assembly 708 is configured to drain the lower processing volume 739 rapidly. In certain embodiments, the draining assembly 708 has a plurality of draining ports 709, each configured to form an independent draining path dedicated to a particular processing fluid. In certain embodiments, each of the independent draining paths may be connected to a negatively pressurized sealed container for fast draining of the processing fluid in the lower processing volume 739. Similar fluid supply and draining configuration may be found in FIGS. 9-10 of U.S. patent application Ser. No. 11/445,707, filed Jun. 2, 2006, which is incorporated herein by reference.

In certain embodiments, a megasonic transducer 704 is disposed behind a window 705 in the bottom wall 703. The megasonic transducer 704 is configured to provide megasonic energy to the lower processing volume 739. The megasonic transducer 704 may comprise a single transducer or an array of multiple transducers, oriented to direct megasonic energy into the lower processing volume 739 via the window 705. When the megasonic transducer 704 directs megasonic energy into processing fluid in the lower processing volume 739, acoustic streaming, i.e. streams of micro bubbles, within the processing fluid may be induced. The acoustic streaming aids the removal of contaminants from the substrate being processed and keeps the removed particles in motion within the processing fluid hence avoiding reattachment of the removed particles to the substrate surface.

In certain embodiments, a pair of megasonic transducers 715a , 715b , each of which may comprise a single transducer or an array of multiple transducers, are positioned behind windows 716 at an elevation below that of the weir 717, and are oriented to direct megasonic energy into an upper portion of lower processing volume 739. The transducers 715a and 715b are configured to direct megasonic energy towards a front surface and a back surface of a substrate respectively.

The transducers 715a and 715b are preferably positioned such that the energy beam interacts with the substrate surface at or just below a gas/liquid interface (will be described below), e.g. at a level within the top 0-20% of the liquid in the lower processing volume 739. The transducers may be configured to direct megasonic energy in a direction normal to the substrate surface or at an angle from normal. Preferably, energy is directed at an angle of approximately 0-30 degrees from normal, and most preferably approximately 5-30 degrees from normal. Directing the megasonic energy from the transducers 715a and 715b at an angle from normal to the substrate surface can have several advantages. For example, directing the energy towards the substrate at an angle minimizes interference between the emitted energy and return waves of energy reflected off the substrate surface, thus allowing power transfer to the solution to be maximized. It also allows greater control over the power delivered to the solution. It has been found that when the transducers are parallel to the substrate surface, the power delivered to the solution is highly sensitive to variations in the distance between the substrate surface and the transducer. Angling the transducers 715a and 715b reduces this sensitivity and thus allows the power level to be tuned more accurately. The angled transducers are further beneficial in that their energy tends to break up the meniscus of fluid extending between the substrate and the bulk fluid (particularly when the substrate is drawn upwardly through the band of energy emitted by the transducers)—thus preventing particle movement towards the substrate surface.

Additionally, directing megasonic energy at an angle to the substrate surface creates a velocity vector towards the weir 717, which helps to move particles away from the substrate and into the weir 717. For substrates having fine features, however, the angle at which the energy propagates towards the substrate front surface must be selected so as to minimize the chance that side forces imparted by the megasonic energy will damage fine structures.

It may be desirable to configure the transducers 715a and 715b to be independently adjustable in terms of angle relative to normal and/or power. For example, if angled megasonic energy is directed by the transducer 715a towards the substrate front surface, it may be desirable to have the energy from the transducer 715b propagate towards the back surface at a direction normal to the substrate surface. Doing so can prevent breakage of features on the front surface by countering the forces imparted against the front surface by the angled energy. Moreover, while a relatively lower power or no power may be desirable against the substrate front surface so as to avoid damage to fine features, a higher power may be transmitted against the back surface (at an angle or in a direction normal to the substrate). The higher power can resonate through the substrate and enhance microcavitation in the trenches on the substrate front, thereby helping to flush impurities from the trench cavities.

Additionally, providing the transducers 715a , 715b to have an adjustable angle permits the angle to be changed depending on the nature of the substrate (e.g. fine features) and also depending on the process step being carried out. For example, it may be desirable to have one or both of the transducers 715a , 715b propagate energy at an angle to the substrate during the cleaning step and then normal to the substrate surface during the drying step (see below). In some instances it may also be desirable to have a single transducer, or more than two transducers, rather than the pair of transducers 715a , 715b.

The rotational alignment of the substrate prior to entry into the substrate process chamber 30 may also be selected to reduce damage to features on the device. The flow of fluid through the lower processing volume 739 during megasonic cleaning applies a force on the features and the force can be substantially reduced by orienting the substrate in a direction most resistant to the force. For many substrates the direction most resistant to the force is 45 degrees from a line parallel to sidewalls 738 of features that may be damaged by the force. However, the direction most resistant to the force can be 90 degrees if all sidewalls that may be damaged are aligned in one direction.

In certain embodiments, the chamber lid 710 may have integrated vapor nozzles 721 and exhaust ports 719 for supplying and exhausting one or more vapor into the upper processing volume 713. During process, the lower processing volume 739 may be filled with a processing liquid coming in from the inlet manifold 740 and the upper processing volume 713 may be filled with a vapor coming in from the vapor nozzles 721 on the chamber lid 710. A liquid vapor interface 743 may be created in the chamber body 701. In certain embodiments, the processing liquid fills up the lower processing volume 739 and overflows from the weir 717 and the liquid vapor interface 743 is located at the same level as the weir 717.

During processing, a substrate being processed in the substrate process chamber 30 is first immersed in the processing liquid in the lower processing volume 739, and then pulled out of the processing liquid. It is desirable that the substrate is free of the processing liquid after being pulled out of the lower processing volume 739. In certain embodiments, the Marangoni effect, i.e. the presence of a gradient in surface tension will naturally cause the liquid to flow away from regions of low surface tension, is used to remove the processing liquid from the substrate. The gradient in surface tension is created at the liquid vapor interface 743. In certain embodiments, an isopropyl alcohol (IPA) vapor is used to create the liquid vapor interface 743. When the substrate is being pulled out from the processing liquid in the lower processing volume 739, the IPA vapor condenses on the liquid meniscus extending between the substrate and the processing liquid. This results in a concentration gradient of IPA in the meniscus, and results in so-called Marangoni flow of liquid from the substrate surface.

As shown in FIG. 7, the opening 744, which is configured to allow the substrate transfer assembly 702 in and out the chamber body 701, is formed near a center portion of the chamber lid 710. The integrated vapor nozzles 721 are connected to a pair of inlet channels 720 formed on either side of the opening 744 in the chamber lid 710. In certain embodiments, the vapor nozzles 721 may be formed in an angle such that the vapor is delivered towards the substrate being processed. The exhaust ports 719 are connected to a pair of exhaust channels 718 formed on either side of the opening 744. Shown in FIG. 2, each of the inlet channels 720 may be connected to an inlet pipe extending from the chamber lid 710. The inlet pipes may be further connected to a vapor source. In certain embodiments, the vapor nozzles 721 may be used to supply a gas, such as nitrogen, to the upper processing volume 713. Each of the exhaust channels 718 may be connected to an exhaust pipe extending from the chamber lid 710. The exhaust pipes may be further connected to a pump system for removing vapor from the upper processing volume 713.

The substrate transfer assembly 702 comprises a pair of posts 728 connected to a frame 727. The frame 727 may be connected with an actuator mechanism configured to move the substrate transfer assembly 702 vertically. An end effector 729 configured to receive and secure a substrate by an edge is connected to a terminal end of each of the posts 728. Each of the end effectors 729 is configured to provide lateral and radial support to the substrate while the substrate transfer assembly 702 moves the substrate to and from the chamber body 701. In certain embodiments, two pairs of rod members 730 may be extended from the end effector 729 to provide lateral support to the substrate and a groove 731 formed between each pair of the rod members 730 may be configured to provide radial support to the substrate. In certain embodiments, the top pair of rod members 730 of each end effector 729 is positioned on the same level and the straight line connecting the top pairs of rod members 730 is close to or passes the center of the substrate being supported thereon.

In certain embodiments, a purge gas may be used following the Marangoni process to remove any residual processing liquid on the substrate. A directed purge assembly 722 may be attached to an upper surface 745 of the chamber lid 710. The directed purge assembly 722 is configured to provide a gas flow to the substrate as the substrate is being removed from the substrate process chamber 30. The residual fluid retained at the contact region between the end effector and substrate is removed upon exposure to a gas flow delivered from the directed purge assembly 722. The residual fluid may be removed because of the pushing force from the gas flow and/or the drying effect of the gas flow. A variety of gases may be used for the gas flow, for example air, and non-reactive gases, such as nitrogen, argon, carbon dioxide, helium or the combination thereof. In certain embodiments, the gas used in the gas flow may be heated to increase the drying effect.

The directed purge assembly 722 may comprise a pair of nozzle assemblies 747 each positioned on one side of the opening 744 and configured to provide a gas flow to one side of the substrate. Each of the nozzle assembly 747 comprises a bottom member 724 attached to the chamber lid 710 and an upper member 723 attached to the bottom member 724. An inlet port 725 may be connected to each nozzle assembly 747. One or more nozzles 726 in fluid communication with the inlet port 725 may be formed between the bottom member 724 and the upper member 723. The one or more nozzles 726 may be blade shaped, a drilled hole, or an engineered nozzle.

The gas flow from the nozzles 726 may have a flow rate in the range of about 5 liters per minute per nozzle to about 50 liters per minute per nozzle. In certain embodiments, the gas flow rate is about 40 liters per minute per nozzle. When the substrate is being removed from the chamber body 701, the distance between the nozzles 726 to the substrate may be in the range of about 1 mm to about 50 mm. In certain embodiments, the distance between the nozzles 726 to the substrate may be about 15 mm. In another embodiment, the nozzles 726 may be movable so that the distance between the nozzles 726 and the substrate is adjustable to suit different processing requirements. In certain embodiments, the nozzles 726 may be oriented such that the gas flow from the nozzles 726 has an angle of about 15° from a surface of the substrate. In certain embodiments, the gas flow delivered from the nozzles 726 may be horizontal, i.e. parallel to the upper surface 745 of the chamber lid 710.

In operation, after the final treatment and rinse steps are carried out, the substrate is dried within the process chamber 30. Drying may be performed in a number of ways--three of which will be described below. Each of the three examples utilizes an IPA vapor preferably carried into the process chamber 30 by a nitrogen gas flow. In each example, the IPA vapor is preferably generated in an IPA vapor generator 330, using one of a variety of IPA generation procedures known those skilled in the art. When the IPA vapor is needed in the process chamber 30, nitrogen gas is passed through nitrogen supply line 332 into the first IPA vapor generator 330, and carries the IPA vapor out of the first IPA vapor generator 330 via second supply line 206 to one of the inlet ports 707 in process chamber 30.

The three examples of drying processes using the IPA vapor will next be described. In certain embodiments, the bulk water used for the final rinse may be rapidly discharged from the process chamber 30 by rapidly withdrawing the fluid into a negative pressure container. Then a vapor of isopropyl alcohol is introduced into the process chamber 30 via one of the inlet ports 707. The IPA vapor passes into the lower processing volume 739 of the process chamber 30 and condenses on the surface of the substrate where it reduces the surface tension of the water attached to the substrate, and thus causes the water to sheet off of the substrate surfaces. Any remaining liquid droplets may be evaporated from the substrate surface using gas, such as heated nitrogen gas, introduced through gas inlet port 725. Gas inlet port 725 may include a gas manifold having outlets that are angled downwardly. The end effector 729 may be used to move the substrate past this manifold to accelerate evaporation of remaining IPA/water film from the surface of the substrate.

In an alternative drying process, an atmosphere of IPA vapor may be formed in the upper processing volume 713 by introducing the vapor via inlet port 707. According to this embodiment, the substrate transfer assembly 702 lifts the substrate from the lower processing volume 739 into the IPA atmosphere in the upper processing volume 713, where the IPA vapor condenses on the surface of the substrate, causing the surface tension of the water attached to the substrate to be reduced, and thus causing the water to sheet from the substrate surface.

The megasonic transducers 715a , 715b may be energized as the substrate is pulled from the DI water so as to create turbulence in zone Z to thin the boundary layer of fluid attached to the substrate. With the boundary thinned by zone Z, IPA can diffuse more quickly onto the surface of the substrate, thus leading to faster drying with less IPA usage. Thus, the substrate may be withdrawn into the IPA atmosphere relatively quickly, i.e. preferably at a rate of 30 mm/sec or less, and most preferably at a rate of between approximately 8 mm/sec-30 mm/sec. This is on the order of ten times faster than prior extraction drying methods, which utilize a slow withdrawal (e.g. 0.25 to 5 mm/sec) to facilitate a surface-tension gradient between fluid attached to the substrate and the bulk rinse water.

Again, gas such as heated nitrogen may be introduced via nozzles 726 to evaporate any remaining IPA and/or water film, and the substrate may be translated past the nozzles 726 to accelerate this evaporation process.

In a third alternative embodiment, slow extraction-type drying may be utilized. The substrate may thus be slowly drawn from the bulk DI water into the IPA vapor. Using this embodiment, the IPA condenses on the liquid meniscus extending between the substrate and the bulk liquid. This results in a concentration gradient of IPA in the meniscus, and results in so-called Marangoni flow of liquid from the substrate surface. Gas such as heated nitrogen gas may be directed from nozzles 726 onto the substrate to remove some of the residual water and/or IPA droplets and/or film. The substrate may be moved past nozzles 726 to accelerate this evaporation step.

While the foregoing is directed to embodiments of the present invention, other and further embodiments of the invention may be devised without departing from the basic scope thereof, and the scope thereof is determined by the claims that follow.

1. A system for cleaning a batch of substrates, comprising:
a first cluster of vertical processing chambers;
an IPA reservoir; and
an IPA delivery system in fluid communication with the IPA reservoir and the first cluster of vertical processing chambers and adapted to transfer IPA vapor between the IPA reservoir and the first cluster of vertical processing chambers.

2. The system of claim 1, further comprising:
a first main circulation tank;
a second main circulation tank;
a reservoir-cluster recirculation circuit in fluid communication with the first main circulation tank and the second main circulation tank and with each processing chamber in the first cluster of vertical processing chambers; and
a dosing circuit comprising a plurality of additive sources in fluid communication with the first main circulation tank and the second main circulation tank.

3. The system of claim 1, wherein the first cluster of vertical processing chambers comprises at least three vertical processing chambers.

4. The system of claim 2, further comprising a second cluster of vertical processing chambers in fluid communication with the reservoir-cluster recirculation circuit.

5. The system of claim 1, wherein the IPA delivery system further comprises:
a metered pump in fluid communication with the IPA reservoir;
a vapor generator in fluid communication with the metered pump; and
a nitrogen source in fluid communication with the vapor generator.

6. The system of claim 5, further comprising a heater in communication with the nitrogen source.

7. The system of claim 1, wherein the vertical process chamber comprises:
a chamber having an upper opening, a lower process volume and an upper process volume, wherein the lower process volume is configured to retain a processing fluid; and
a drying gas delivery assembly in fluid communication with the fluid delivery system, wherein the drying gas delivery assembly is disposed outside the chamber near the upper opening.

8. The system of claim 2, wherein the plurality of additive sources comprises:
a first reservoir containing hydrofluoric acid;
a second reservoir containing hydrochloric acid;
a third reservoir containing ammonium hydroxide; and
a fourth reservoir containing hydrogen peroxide.

9. The system of claim 8, wherein the first main circulation tank is in fluid communication with the first reservoir (hydrofluoric acid) and the second main circulation tank is in fluid communication with the third reservoir (ammonium hydroxide) and the fourth reservoir (hydrogen peroxide).

10. A system for cleaning a batch of substrates, comprising:
at least three vertical processing chambers each configured to process a single substrate; and
a fluid delivery system in fluid communication with each of the at least three vertical processing chambers, the fluid delivery system configured to provide IPA vapor to each of the at least three vertical processing chambers.

11. The system of claim 10, wherein the fluid delivery system comprises:
a fluid reservoir coupled to an IPA source;
a metered pump in fluid communication with the fluid reservoir;
a vapor generator in fluid communication with the metered pump; and
a nitrogen source in fluid communication with the vapor generator.

12. The system of claim 11, further comprising a heater in communication with the nitrogen source.

13. The system of claim 10, wherein the vertical process chamber comprises:
a chamber having an upper opening, a lower process volume and an upper process volume, wherein the lower process volume is configured to retain a processing fluid; and
a drying gas delivery assembly in fluid communication with the fluid delivery system, wherein the drying gas delivery assembly is disposed outside the chamber near the upper opening.

14. The system of claim 13, wherein the drying gas delivery assembly comprises a gas nozzle configured to direct a drying gas towards a surface of the substrate.

15. The system of claim 14, wherein the drying gas delivery assembly comprises:
a first pair of gas nozzles positioned on one side of the upper opening; and
a second pair of gas nozzles positioned on an opposite side of the upper opening relative to the first pair of gas nozzles, wherein each of the gas nozzles is configured to direct a drying gas towards a surface of the substrate.

16. A system for cleaning a batch of substrates, comprising:
a system platform having at least three vertical processing chambers each configured to process a single substrate; and
a fluid delivery system in fluid communication with each of the at least three vertical processing chambers.

17. The system of claim 16, wherein the fluid delivery system further comprises an IPA delivery system comprising:
a fluid reservoir coupled to an IPA source;
a metered pump in fluid communication with the fluid reservoir;
a vapor generator in fluid communication with the metered pump; and
a nitrogen source in fluid communication with the vapor generator.

18. The system of claim 17, wherein the fluid delivery system further comprises a dosing circuit comprising:
a first plurality of additive sources; and
a metered pump in fluid communication with each of the additive sources.

19. The system of claim 18, wherein the first plurality of additive sources comprises:
a first reservoir for providing hydrofluoric acid;
a second reservoir for providing hydrochloric acid;
a third reservoir for providing ammonium hydroxide; and
a fourth reservoir for providing hydrogen peroxide.

20. The system of claim 19, wherein the fluid delivery system further comprises a recirculation circuit comprising:
a first main circulation tank in fluid communication with the first reservoir (hydrofluoric acid); and
a second main circulation tank in fluid communication with the third reservoir (ammonium hydroxide) and the fourth reservoir (hydrogen peroxide), wherein the recirculation system is in fluid communication with each of the processing cells.
